(19) United States
(12) Patent Application Publication
(10) Pub. No.: US 2018/0041273 A1
(43) Pub. Date: Feb. 8, 2018

(54) Portable Device with Light Fidelity Module

(71) Applicants: Kuo-Ching CHIANG, New Taipei City (TW); Yi-Chuan CHENG, Changhua County (TW)

(72) Inventors: Kuo-Ching CHIANG, New Taipei City (TW); Yi-Chuan CHENG, Changhua County (TW)

(21) Appl. No.: 15/226,937

(22) Filed: Aug. 3, 2016

(51) Int. Cl. H04B 10/116; H04B 1/3827

(52) U.S. Cl. CPC H04B 10/116; H04B 1/3827

(57) ABSTRACT

A portable communication device comprises a control unit, a light fidelity module coupled to the control unit, wherein the light fidelity module is used for transmitting a visible light to another portable communication device and receiving a visible light from another portable communication device; and a digital code processing unit coupled to the control unit, wherein the digital code processing unit is used for encoding or decoding data transmitted to or received from the light fidelity module.

### TECHNICAL FIELD

The present invention generally relates to a portable device, in particular, to a portable device with a light fidelity module for data exchanging between the portable devices.

### DESCRIPTION OF RELATED ARTS

Because of the development of the information technology (IT), the information could be exchanged with higher capacity and faster speed. Internet is designed as an open structure to exchange information freely without restriction. The third generation mobile phone standard allows the user access video communication through air. Thus, certain communication service requiring real time information exchange, such as viewing live video, has become feasible through mobile phone communication network or Internet. Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone. In pace with the development of information and computer technology, the electronic products grow rapidly with the trend of small size, multifunction and high operation speed. Based on the development of cellular integration technology, communication systems have also been introduced to allow users obtain information more convenient. Thus, the business accompanied with the communication device flourish as well due to the development of the communication technology. The internet and communication service providers also offer business services to assist clients to transfer information or extend the market. The cellular manufactures have to release new models with different appearances, function and styles more frequently so as to attract the attention of the buyer and occupy a favorable marketing share. Communication services providers or information services providers also have to provide diverse, comprehensive and latest information to clients. The demand for voice and mainly high end data services like VOIP, video calling, instant messaging by the user is rapidly increasing as the consumer needs better and efficient ways of transferring data which are large and often need a high level of encryption. The existing radio spectrum fails to cater this burgeoning need and faces various other issues like scalability and availability. Thus, the present invention is introduced to overcome aforementioned shortcoming.

### SUMMARY

A mobile phone comprises a control unit, a visible light source configured to transmit a first visible light to another mobile phone, wherein the visible light source module includes a rear light source or a front light source; a photo detector adapted to receive the visible light transmitted from another mobile phone; and a visible light digital code processing unit coupled to the control unit, wherein the visible light digital code processing unit is used for encoding or decoding transmitted to or received data.

According to an aspect of the invention, the visible light source includes a display back light source. The visible light source includes LED, OLED, field emission or laser device. The mobile phone further includes a visible light driver and a signal amplification and processing unit. Aforementioned mobile phone further comprises a memory, a display, an image capturing device, a wireless data transferring module which coupled to the control unit. The mobile phone further comprises an Internet communication module, a transceiver which coupled to the control unit.

### BRIEF DESCRIPTION OF THE DRAWINGS

FIG. 1 shows the functional diagram of the present invention.

FIG. 2 shows the functional diagram of the present invention.

FIG. 3 shows the embodiment of the present invention.

### DETAILED DESCRIPTION OF THE DISCLOSURE

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

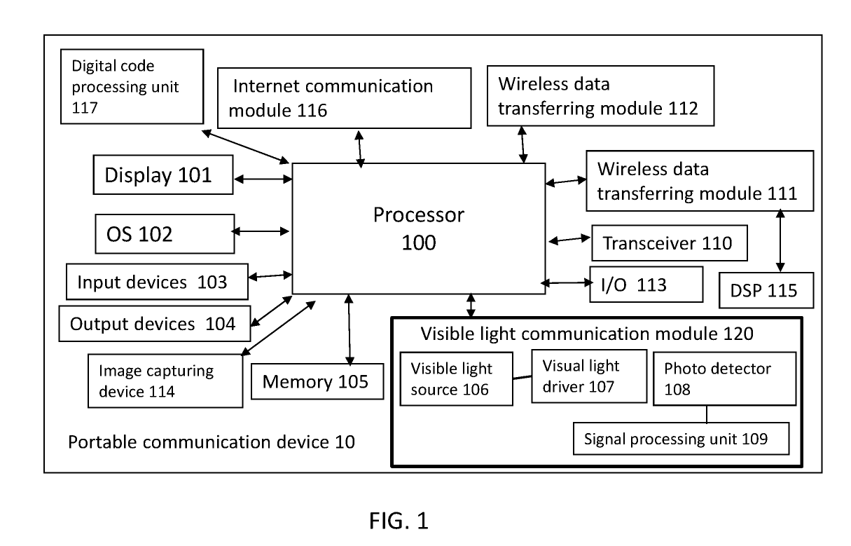

FIG. 1 is a functional diagram depicting an exemplary portable communication device 10 including a variety of optional hardware and software components. Any components in the mobile device can communicate with any other component, although not all connections are shown, for ease of illustration. The portable communication device 10 can be any of a variety of computing devices (e.g., cell phone, smart phone, Personal Digital Assistant (PDA), tablet etc.) and can allow wireless two-way communications with one or more mobile communications networks, such as a cellular or satellite network, and two-way light communication between the portable communication device 10 and others portable communication devices.

The illustrated portable communication device 10 can include a controller (control IC) or processor 100 (e.g., signal processor, microprocessor, ASIC, or other control and processing logic circuitry) for performing such tasks as signal coding, data processing, input/output processing, power control, and/or other functions. An operating system (OS) 102 can control the allocation and usage of the components and support for one or more application programs, which can include common mobile computing applications (e.g., email applications, calendars, contact managers, web browsers, messaging applications), or any other computing application.

The illustrated portable communication device 10 can include memory 105 which can include non-removable memory and/or removable memory. The non-removable memory can include RAM, ROM, flash memory, a hard disk, or other well-known memory storage technologies. The removable memory can include flash memory or a Subscriber Identity Module (SIM) card, which is well known in GSM communication systems, or other well-known memory storage technologies, such as “smart cards”. The memory can be used for storing data and/or code for running the operating system 102 and the applications. Example data can include web pages, text, images, sound files, video data, or other data sets to be sent to and/or received from one or more network servers or other devices via one or more wired or wireless networks. The memory can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The portable communication device 10 can support one or more input devices 103, such as a touch screen, camera, microphone and keypads, and one or more output devices 104, such as a speaker and a display 101. Some devices can serve more than one input/output function. For example, the touch screen and the display 101 can be combined in a single input/output device. The touch screen can support multiple functional icons. The icons can be displayed on a home (touch) screen, which is typically the screen displayed when the portable device is powered on. The home screen is the base screen that generally cannot be further minimized and that contains icons representing applications. As further described below, each icon is represented by an image based on its respective application.

The portable communication device 10 includes at least one wireless data transferring module 111. The wireless data transferring module 111 could be RF module to transmit or receive mobile phone signal, which includes audio data, video data, image data, text data and the combination thereof. As known in the art, the RF module is coupled to an antenna system. The RF module may include base band processor and so on. This antenna is connected to a transceiver, which is used to receive and transmit signal. The wireless data transferring module 111 is compatible to the mobile phone protocol such as W-CDMA CDMA2000 CDMA2001 TD-CDMA TD-SCDMA UWC-136 DECT 4G system. There systems allow the user communicates with video communication. The RF module may perform the function of signal transmitting and receiving, frequency synthesizing, base-band processing and digital signal processing. The SIM card hardware interface is used for receiving a SIM card. Finally, the signal is send to the final actuators, i.e. a vocal I/O unit 113 including a loudspeaker and a microphone. The module 111 can be formed by separated module (chip) or integrated chip. A wireless data transferring module 111 can be coupled to an antenna and can support two-way communications between the processor 100 and external devices, as is well understood in the art.

The device 10 further includes the second wireless data transferring module 112. In one embodiment, a wireless local area network (WLAN) module is employed and it could be compatible to the local area network protocol or standard such as Bluetooth standard, Wi-Fi standard, or 802.11x (x refers to a, b, g, n) standard compatible module. Further, the wireless local area network (WLAN) module could be compatible to the WiMAX (Worldwide Interoperability for Microwave Access) standard or specification. An Internet communication module 116 are coupled to the central control unit 100 to allow transmit and receive the audio, video or both type signal to/from the internet network through the wireless local area wireless transmission module. Internet communication module 116 at least meets the standard of terminal-terminal Voice Over Internet Protocol (VoIP). One of the examples is Skype compatible protocol. By using of the Internet communication module 116 and the wireless local area network module, the user may portably, synchronously transmit and receive the vocal, video or both signal through the internet by using the internet (software) communication module 116. The present invention defines a hand-held device having VoIP phone module and wireless WiFi or WiMax network linking module coupled to the VoIP phone module to allow the user to make a wireless terminal-terminal VoIP phone without power on the PC. The voice over internet protocol (VoIP) phone module is used to encode or convert the voice signal into VoIP protocol within the portable communication device before transmitting the signal, followed by programming the signal into WiFi or WiMax format in order to transmit the voice signal through the wireless network, especially, the Skype phone.

The portable communication device 10 can further include at least one input/output port, a power supply, a satellite navigation system receiver, such as a Global Positioning System (GPS) receiver, an accelerometer, and/or a physical connector, which can be a USB port, IEEE 1394 (FireWire) port, and/or RS-232 port. The illustrated components are not required or all-inclusive, as any components can be deleted and other components can be added. For example, the device 10 may include DSP (digital signal processor) 115, A/D converter (not shown) and a transceiver (receiver and transmitter) 110.

An image capturing module 114 is required and coupled to the central control unit 100 to catch the video image if the user would like to conduct the real-time video transmission. The image capturing module 114 could be digital still camera, digital video camera. Therefore, the real-time portable conference is possible. The image capturing module 114 includes CMOS or CDD. Pluralities of micro-lens are configured over the CMOS or CCD. In another embodiment, the one difference is that the device may omit the RF module. If the device 10 includes 3G or higher level RF module, the user may transmit the video phone through the air. Therefore, the user may select one of the schemes to make a video call through internet or air depending on the user demand If the device is within the hot spot area, the user may choose the usage of the internet phone module for communication due to cheaper transmitting fee. If the out of the hot spot range, the other option for video communication is provided. Typically, the WCDMA signal is less restricted by the geography limitation, but the transmission fee is higher. The present invention allows the user to select the proper wireless module for video communication. If the user would like to conduct the video communication through WiFi or WiMax, the method includes coupling to internet or hot spot, followed by activating the internet (software) phone module. Subsequently, vocal signal is input from the speaker and image data is captured from the image capture device, subsequently, the image data and the vocal signal are converted from signal to digital. After the conversion, the image data and the vocal signal are composition, compressed or processed to form a data streams.

The device 10 also includes a digital code processing unit or CODEC (coder/decoder) 117 coupled to the processor 100. The digital code processing unit 117 may process and decode or encode the data transmitted to or received from the light fidelity module 120. The device includes but not limited to cellular phone, PDA (personal digital assistant), smart phone, notebook, digital still camera, digital video camera, medium player (MP3, MP4), GPS and the equivalent thereof.

The device 10 further includes a visible light communication device (module) 120 coupled to the processor 100. In one case, the visible light communication device or module 120 is a light fidelity device (module). The visible light communication device 120 is a bidirectional, high-speed and fully networked wireless communication technology, and is a form of visible light communication and a subset of optical wireless communications and could be a complement to RF communication (Wi-Fi or cellular networks), it may be employed for data broadcasting. The visible light communication device 120 uses visible light for transmitting data. The visible light spectrum is 10,000 times larger than the entire radio frequency spectrum. The optical orthogonal frequency-division multiplexing (O-OFDM) modulation methods have been optimized for data rates.

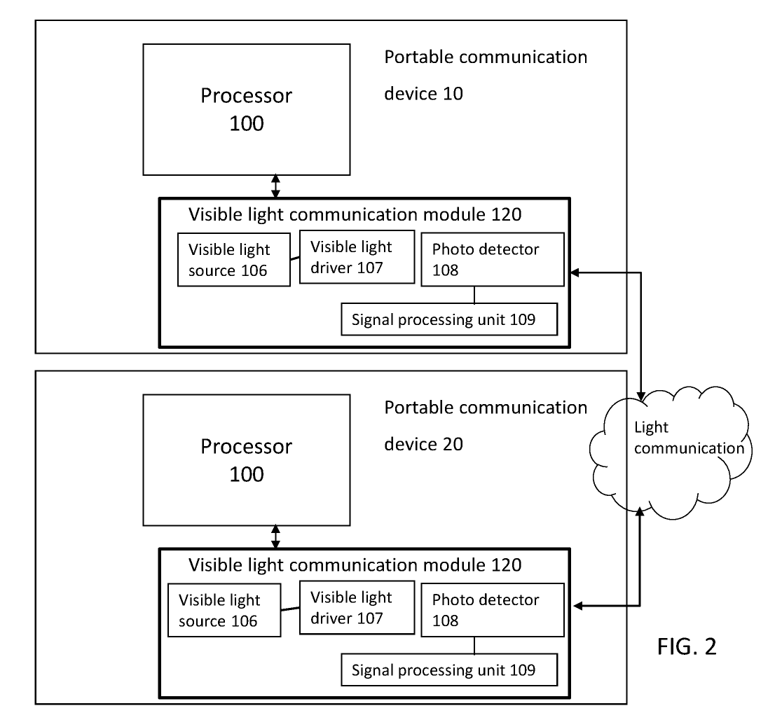

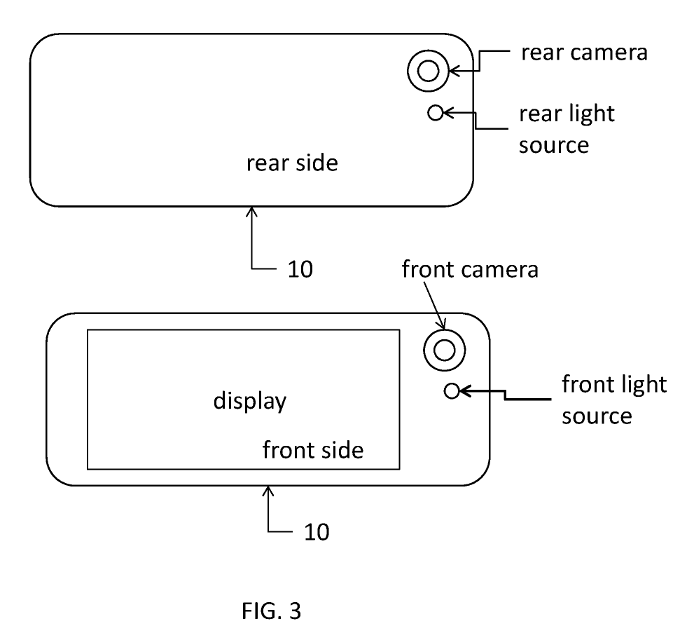

In the present invention, the visible light communication device or module 120 includes at least one visible light source 106, for example, OLED light source, LED light source, field emission light source or laser device, a light driver 107, a photo detector 108, and a signal amplification and processing unit 109. The visible light source 106 is driven by the light driver 107. In one example, the visible light source 106 is a rear light source or a front light source for a rear camera or a front camera, shown in FIG. 3. In another example, the visible light source 106 is a display back light source, please refer to FIG. 3. Data may be encoded in the light by varying the rate at which the visible light source flicker (for example, LEDs flicker) on and off to give different strings of 1s and 0s (logical value). In one example, if the visible light source is on, a digital 1 is transmitted; and if the visible light source is off, a digital 0 is transmitted. The visible light source (for example, LED, OLED, field emission light source, and laser) can be switched on and off very quickly, which gives nice opportunities for transmitting data. It is required that some visible light source and a controller that code data into those visible light. It has to do is to vary the rate at which the visible light source flicker depending upon the data we want to encode. The visible light source (for example LED) intensity is modulated so rapidly that human eyes cannot notice, so the output appears constant. The visible light source device 106 of the portable communication device 10 can stream data embedded in its light beams at ultra-high speed to the photo detector 108 of another portable communication device 20, shown in FIG. 2. Similarly, the LEDs device 106 of the portable communication device 20 can stream data embedded in its light beams at ultra-high speed to the photo detector 108 of another portable communication device 10, shown in FIG. 2. Namely, the photo detector 108 of the portable communication device 10 may receive the data from the portable communication device 20. Thus, the portable communication device 10 can exchange data with the portable communication device 20 by the light fidelity module 120. The photo detector 108 converts light signals into voltage or current. For example, the photo detector 108 of the portable communication device 20 is converting the tiny change in amplitude of the light beams into an electrical current signal, and then converting back into a data stream by the signal amplification and processing unit 109.

For example, the signal amplification and processing unit 109 is a transimpedance amplifier (TIA) which is a current-to-voltage converter, most often implemented using an operational amplifier. The TIA can be used to amplify the current output of the photo detectors 108 (such as photodiodes) or other types of sensors to a usable voltage. There is a method of parallel data transmission using array of LEDs, where each LED transmits a different data stream. Another method is using mixtures of red, green and blue LED (or OLED, field emission light source, laser) to alter the light's frequency, with each frequency encoding a different data channel. Such advancements promise a theoretical speed of 1 Gbps, which means one can download a full high-definition film in just 30 seconds.

It will be understood that the above descriptions of embodiments are given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

1. A mobile phone, comprising:
a control unit;
a visible light source configured to transmit a first visible light to another mobile phone, wherein said visible light source mix at least two colors of light to transmit multiple data streams at different color frequencies;
a photo detector adapted to receive a second visible light transmitted from said another mobile phone; and
a digital code processing unit coupled to said control unit and configured to encode or decode said multiple data streams.

2. The mobile phone as set forth in claim 1, wherein said visible light source includes LED, OLED, field emission or laser device.

3. The mobile phone as set forth in claim 1, further comprising a signal amplification and processing unit.

4. The mobile phone as set forth in claim 1, further comprising a display coupled to said control unit.

5. The mobile phone as set forth in claim 1, further comprising an image capturing device coupled to said control unit.

6. The mobile phone as set forth in claim 1, further comprising a visible light driver.

7. The mobile phone as set forth in claim 1, further comprising a wireless data transferring module coupled to said control unit.

8. The mobile phone as set forth in claim 7, wherein said wireless data transferring module is Bluetooth standard, Wi-Fi standard, or 802.11x (x refers to a, b, g, n) standard compatible module.

9. The mobile phone as set forth in claim 1, further comprising an Internet communication module coupled to said control unit.

10. The mobile phone as set forth in claim 1, wherein number of said multiple data streams is at least four.

11. A mobile phone, comprising:
a control unit;
a mixed light source configured to transmit light to another mobile phone, wherein said mixed light source includes three color frequencies, wherein said mixed light source mix at least two colors frequencies to transmit multiple data streams at different color frequencies; and
a photo detector adapted to receive a signal transmitted from said another mobile phone.

12. The mobile phone as set forth in claim 11, wherein said mixed light source includes LED, OLED, field emission or laser device.

13. The mobile phone as set forth in claim 11, further comprising a signal amplification and processing unit.

14. The mobile phone as set forth in claim 11, further comprising a display coupled to said control unit.

15. The mobile phone as set forth in claim 11, further comprising an image capturing device coupled to said control unit.

16. The mobile phone as set forth in claim 11, further comprising a visible light driver.

17. The mobile phone as set forth in claim 11, further comprising a wireless data transferring module coupled to said control unit.

18. The mobile phone as set forth in claim 17, wherein said wireless data transferring module is Bluetooth standard, Wi-Fi standard, or 802.11x (x refers to a, b, g, n) standard compatible module.

19. The mobile phone as set forth in claim 11, further comprising an Internet communication module coupled to said control unit.

20. The mobile phone as set forth in claim 11, wherein number of said multiple data streams is at least four.
